(19) United States
(12) Patent Application Publication
(10) Pub. No.: US 2012/0166990 A1
(43) Pub. Date: Jun. 28, 2012

(54) MENU PROVISION METHOD USING GESTURES AND MOBILE TERMINAL USING THE SAME

(75) Inventors: Seo-Hyun JEON, Yongin-si (KR); Tae-Man Han, Daejeon (KR)

(73) Assignee: Electronics and Telecommunications Research Institute, Daejeon (KR)

(21) Appl. No.: 13/331,738

(22) Filed: Dec. 20, 2011

(30) Foreign Application Priority Data
Dec. 23, 2010 (KR) 10-2010-0133942

(51) Int. Cl. G06F 3/041; G06F 3/048

(52) U.S. Cl. 715/769; 715/810

(57) ABSTRACT

Disclosed herein is a menu provision method using gestures. In the menu provision method, a first gesture of a user which is performed on the specific area of the screen of a mobile terminal is recognized while the function of the mobile terminal is being performed. A menu start sign, which is used for displaying a menu ribbon, is displayed on the screen in response to the first gesture. Thereafter, the menu ribbon is displayed in response to a second gesture of the user which is performed on the menu start sign.

### CROSS REFERENCE TO RELATED APPLICATION

This application claims the benefit of Korean Patent Application No. 10-2010-0133942, filed on Dec. 23, 2010, which is hereby incorporated by reference in its entirety into this application.

### BACKGROUND OF THE INVENTION

1. Technical Field

The present invention relates generally to a technology for providing a menu to a user using a mobile terminal which provides various types of functions, and, more particularly, to a menu provision technology for a mobile terminal, which can remarkably reduce the number of key manipulations in such a way that a menu pops up in response to the gestures of a user.

2. Description of the Related Art

Recently, smart phones provided with touch screens, such as the iPhone produced by Apple, Inc., have been increasingly popularized. Such a smart phone, which has been popularized, recently provides a variety of functions such as making telephone calls, creating text messages, transmitting and receiving e-mails, playing back audio and video, and playing games. Furthermore, the above-described variety of functions may be provided based on multitasking. That is, while a user is running an e-mail program and then writing an e-mail, the user can run a multimedia player program and then play back a video without terminating the e-mail program. Thereafter, the user can return to the e-mail program while the video is being played back. When the multimedia player program is run without the termination of the e-mail program, the e-mail program runs in the background of a smart phone, and is then activated again when the user requests that the e-mail program runs.

A smart phone provided with a touch screen provides a variety of functions based on a touch interface. A user can execute a specific operation by selecting a desired menu item from among various menu items which are displayed in the form of icons. When the user wants to execute another function while executing the specific function of a smart phone, the user should return to an initial menu, or should perform several touch operations in order to search a menu tree for a desired menu item and then execute the found menu item.

Actually, in the case of the Apple iPhone, in order to perform another function while a specific function is being performed, a user should return to the highest menu screen in such a way as to press a home button, and then select a desired menu item again.

The diversification of functions provided by a smart phone has entailed an increase in the number of menu items, so that it has become complicated to execute a desired function using a smart phone. Therefore, there is an urgent need to provide a new menu interface that allows a user to execute a desired function of a smart phone by performing a simple manipulation.

### SUMMARY OF THE INVENTION

Accordingly, the present invention has been made keeping in mind the above problems occurring in the prior art, and an object of the present invention is to enable the user of a mobile terminal to execute a desired menu item using a simple operation without having to return to an initial menu or to perform a complicated process on a menu tree.

Another object of the present invention is to enable the user to easily execute a desired menu item in a multitasking environment.

Still another object of the present invention is to minimize the inconvenience to a user in such a way that a menu start sign is not displayed when a specific function is performed and the menu start sign is visible only when the user inputs a predetermined gesture.

In order to accomplish the above objects, the present invention provides a method of providing a menu using gestures, including recognizing a first gesture of a user which is performed on the specific area of the screen of a mobile terminal while the arbitrary function of the mobile terminal is being performed; displaying a menu start sign, which is used for displaying a menu ribbon, on the screen in response to the first gesture; and displaying the menu ribbon in response to a second gesture of the user which is performed on the menu start sign.

Here, the menu ribbon may be expanded in response to the second gesture. Here, the second gesture may be the gesture of dragging the menu start sign on the screen by the user, and the menu ribbon may be expanded in response to the gesture of dragging the menu start sign on the screen.

Here, the first gesture may be a touch performed by the user on the part of the screen corresponding to the specific area for a preset time period.

Here, the menu start sign may be a part of the menu ribbon.

Here, the method may further include displaying the specific area such that the specific area is distinguished from the other areas of the screen. Here, the displaying may include displaying the brightness of the specific area such that the brightness of the specific area is different from those of the other areas.

Here, the method may further include executing a function corresponding to a selected menu item in the multitasking environment in response to the selection of the menu item on the menu ribbon by the user.

Here, the second gesture may be defined as at least two types of second gestures, and the menu displayed on the menu ribbon may vary depending on the types of the second gesture.

Further, in order to accomplish the above objects, the present invention provides a mobile terminal including a first gesture recognition unit for recognizing a first gesture of a user which is performed on the specific area of a screen while an arbitrary function is being performed; a menu start sign display unit for displaying a menu start sign used for displaying a menu ribbon on the screen in response to the first gesture; and a menu ribbon display unit for displaying the menu ribbon in response to a second gesture of the user which is performed on the menu start sign.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart illustrating a menu provision method using gestures according to an embodiment of the present invention;

FIG. 2 is a view illustrating an example of the screen of a mobile terminal on which a menu is displayed using the menu provision method of FIG. 1;

FIG. 3 is a view illustrating another example of the screen of a mobile terminal on which a menu is displayed using the menu provision method of FIG. 1;

FIG. 4 is a view illustrating further another example of the screen of a mobile terminal on which a menu is displayed using the menu provision method of FIG. 1;

FIG. 5 is a view illustrating an example in which a selected menu item is executed in a multitasking environment in a pop-up manner fashion;

FIG. 6 is a view illustrating an example in which selected menu items are executed in the multitasking environment in a screen division manner; and

FIG. 7 is a block diagram illustrating a mobile terminal according to an embodiment of the present invention.

### DESCRIPTION OF THE PREFERRED EMBODIMENTS

The present invention will be described in detail with reference to the accompanying drawings below. Here, when the description is repetitive and detailed descriptions of well-known functions or configurations would unnecessarily obscure the gist of the present invention, the detailed descriptions will be omitted. The embodiments of the present invention are provided to complete the explanation for those skilled in the art of the present invention. Therefore, the shapes and sizes of components in the drawings may be exaggerated to provide a more exact description.

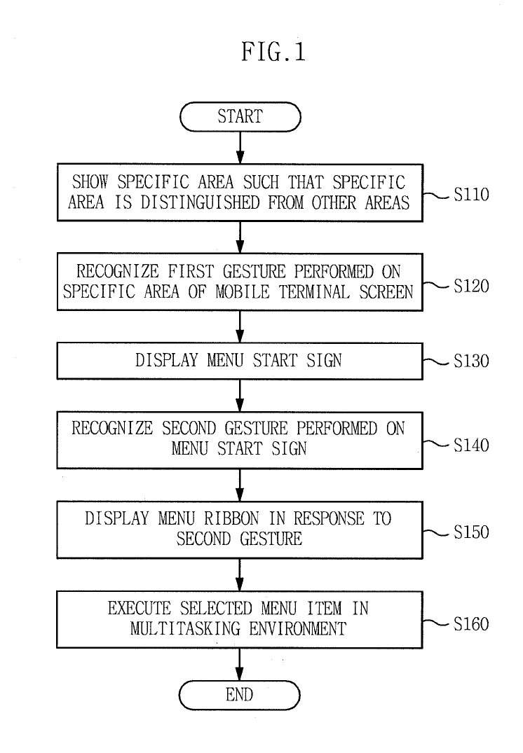

FIG. 1 is a flowchart illustrating a menu provision method using gestures according to an embodiment of the present invention.

Referring to FIG. 1, in the menu provision method using gestures according to the embodiment of the present invention, a specific area of a mobile terminal is displayed such that the specific area is distinguished from the other areas of the mobile terminal at step S110.

At step S110, the brightness of the specific area may be distinguished from those of the other areas. According to an embodiment, the color of the specific area may be distinguished from those of the other areas.

According to an embodiment, a menu start mark repeatedly appears and disappears, so that the specific area may be distinguished from other areas.

Here, the specific area may correspond to any area of the screen of the mobile terminal.

Here, step S110 may be performed by a menu location display unit which will be described later.

Further, in the menu provision method using gestures, a first gesture of a user which is performed on the specific area of the screen of the mobile terminal is recognized while an arbitrary function of the mobile terminal is being performed at step S120.

Here, the first gesture may be a touch of the user which is performed on the specific area of the screen for a predetermined time period.

Here, step S120 may be performed by a first gesture recognition unit which will be described later.

Further, in the menu provision method using gestures, a menu start sign used for displaying a menu ribbon is displayed on the screen in response to the first gesture at step S130.

Here, the menu start sign may be a part of the menu ribbon. That is, when a user touches the specific area for a predetermined time period, the part of the menu ribbon is displayed. When the user pulls the part of the ribbon, the menu ribbon may be displayed.

Here, step S130 may be performed by a menu start sign display unit which will be described later.

Further, in the menu provision method using gestures, a second gesture of the user which is performed on the menu start sign is recognized at step S140.

Here, the second gesture may correspond to the gesture of dragging the menu start sign on the screen.

According to an embodiment, at least two types of second gestures may be defined and different menus may be displayed on the menu ribbon based on the types of the second gesture. That is, a menu, which is displayed when the user touches the menu start sign once and then drags the menu start sign, may be different from a menu, which is displayed when the user touches the menu start sign twice and then drags the menu start sign.

In this manner, menus may be provided based on various types of second gestures.

Here, step S140 may be performed by a second gesture recognition unit which will be described later.

Further, in the menu provision method using gestures, the menu ribbon is displayed using the second gesture at step S150.

Here, the menu ribbon may be expanded in response to the second gesture. That is, when the second gesture corresponds to the operation of pulling the menu start sign, the menu ribbon may be expanded in response to the movement of a finger of a user who drags the menu start sign.

Here, step S150 may be performed by a menu ribbon display unit which will be described later.

The menu displayed on the menu ribbon may be preset or may be set differently for each user. That is, the menu displayed on the menu ribbon may be set by the user as the user desires.

Further, in the menu provision method using gestures, when the user selects a menu item displayed on the menu ribbon, a function corresponding to the selected menu item may be performed in a multitasking environment at step S160.

Here, the function corresponding to the menu item may be performed in a section of the screen of the mobile terminal or in the entire screen. When the function is performed in the entire screen, functions which are being performed in the background may be displayed in a preset portion of the screen.

Here, step S160 may be performed by a menu operation execution unit which will be described later.

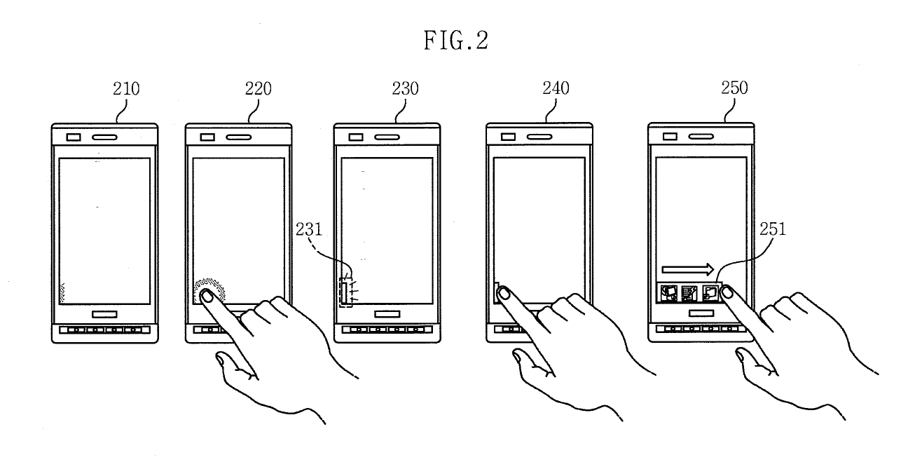

FIG. 2 is a view illustrating an example of the screen of a mobile terminal on which a menu is displayed using the menu provision method of FIG. 1.

Referring to FIG. 2, it can be seen that a specific area of the screen of the mobile terminal is displayed such that the specific area of the screen is distinguished from the other areas of the screen while an arbitrary function (for example, a game) of the mobile terminal is being executed at step 210.

In the example of FIG. 2, the brightness of the specific area is different from those of the other areas, so that the user can distinguish the specific area from other areas.

When the user performs a preset first gesture on the specific area, the mobile terminal recognizes the first gesture at step 220.

In the example of FIG. 2, the first gesture corresponds to a touch performed on the specific area for a preset time period, and the mobile terminal recognizes the touch of the specific area which was performed by the user for the preset time or longer.

When the first gesture is recognized, a menu start sign 231 is displayed on the mobile terminal at step 230.

In the example of FIG. 2, the menu start sign 231 corresponds to a part of a menu ribbon.

When the user touches the menu start sign 231 at step 240 and then drags the menu start sign 231 aside at step 250, a menu ribbon 251 is displayed.

Here, the operation of the user touching the menu start sign 231 and then pulling the menu start sign 231 aside corresponds to a second gesture. That is, the mobile terminal recognizes the second gesture and displays the menu ribbon 251.

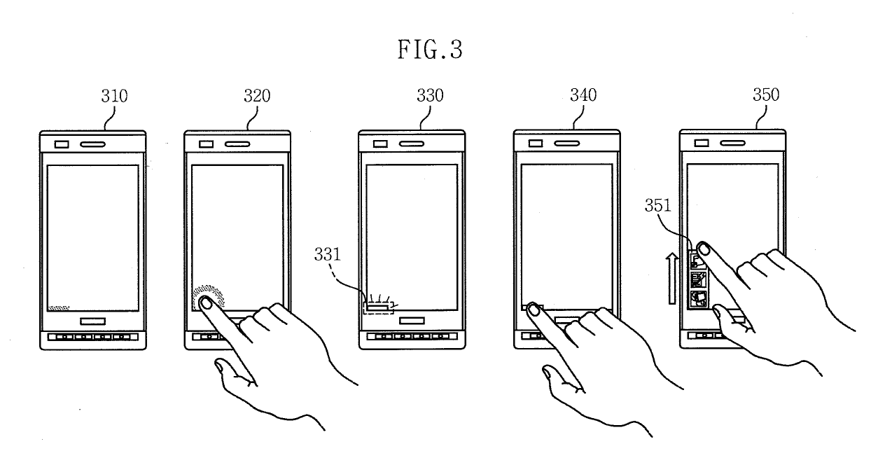

FIG. 3 is a view illustrating another example of the screen of the mobile terminal on which a menu is displayed using the menu provision method of FIG. 1

Referring to FIG. 3, it can be seen that a specific area of the screen of the mobile terminal is displayed such that the specific area of the screen is distinguished from other areas of the screen while an arbitrary function (for example, a game) of the mobile terminal is being executed at step 310.

In the example of FIG. 3, the brightness of the specific area is different from those of the other areas, so that the user can distinguish the specific area from the other areas.

When the user performs a preset first gesture on the specific area, the mobile terminal recognizes the first gesture at step 320.

In the example of FIG. 3, the first gesture corresponds to a touch performed on the specific area for a preset time period, and the mobile terminal recognizes the touch of the specific area which was performed by the user for the preset time or longer.

When the first gesture is recognized, a menu start sign 331 is displayed on the mobile terminal at step 330.

In the example of FIG. 3, the menu start sign 331 corresponds to a part of a menu ribbon.

When the user touches the menu start sign 331 at step 340 and then drags the menu start sign 231 upwards at step 350, a menu ribbon 351 is displayed.

Here, the operation of the user touching the menu start sign 231 and then pulling the menu start sign 331 upwards corresponds to a second gesture. That is, the mobile terminal recognizes the second gesture and displays the menu ribbon 351.

According to an embodiment, when a user touches the specific area for the preset time period or longer, a menu start sign is displayed. Thereafter, when the user drags the menu start sign upwards, a first menu ribbon may be displayed. Furthermore, when the user drags the menu start sign aside, a second menu ribbon may be displayed.

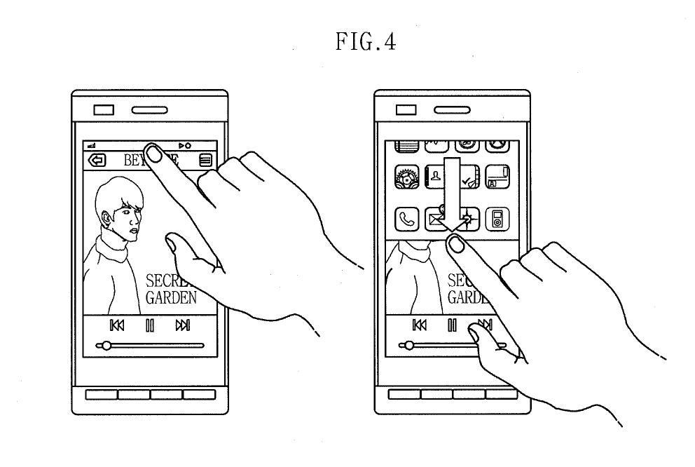

FIG. 4 is a view illustrating further another example of the screen of a mobile terminal on which a menu is displayed using the menu provision method of FIG. 1.

Referring to FIG. 4, it can be seen that the mobile terminal recognizes a first gesture and then displays a menu start sign when a user performs a preset first gesture for a specific area while an arbitrary function (for example, music playback) of the mobile terminal is being performed.

When the user touches the menu start sign and then drags the menu start sign downwards, a menu ribbon is displayed as shown in FIG. 4.

Here, the operation of the user touching the menu start sign and then pulling the menu start sign downwards corresponds to a second gesture. That is, the mobile terminal recognizes the second gesture and then displays the menu ribbon. Although the second gesture corresponds to the operation of pulling the menu start sign downwards in the example of FIG. 4, the second gesture may correspond to one of various types of operations of pulling the menu start sign upwards, to the right, to the left, and downwards.

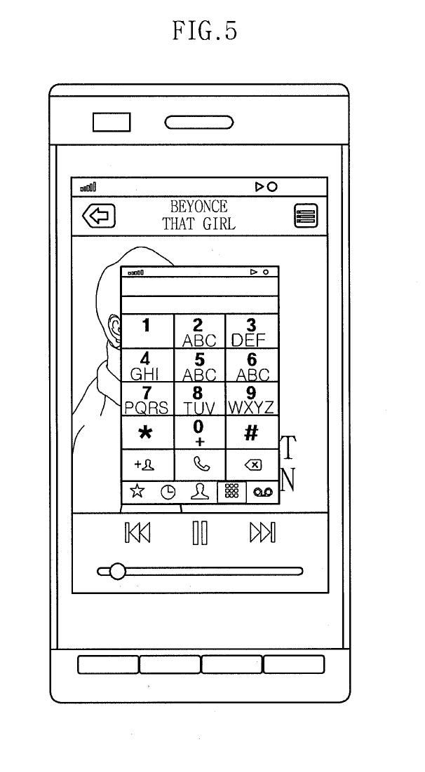

FIG. 5 is a view illustrating an example in which a selected menu item is executed in a multitasking environment in a pop-up manner.

Referring to FIG. 5, it can be seen that, when a menu item corresponding to a dialing operation is selected from a menu, provided by the menu provision method according to the present invention, while music is being played, the dialing operation is executed in a pop-up manner in the multitasking environment.

That is, when a user selects a menu item from a menu included in the menu ribbon, a screen corresponding to an operation corresponding to the selected menu item (dialing in the example of FIG. 5) may appear in a pop-up manner and then be executed.

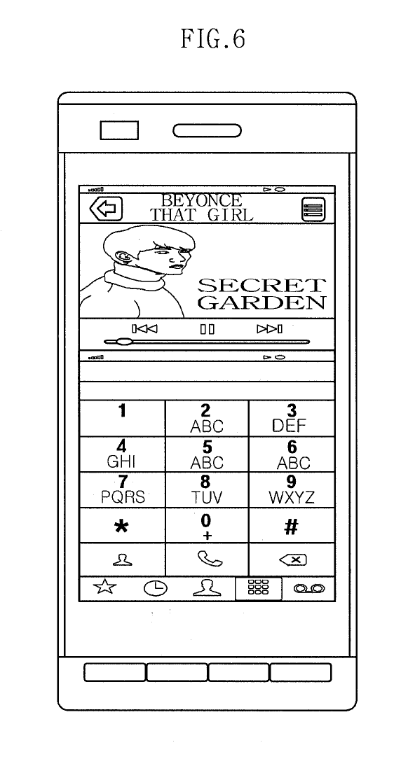

FIG. 6 is a view illustrating an example in which selected menu items are executed in the multitasking environment in a screen division manner.

Referring to FIG. 6, it can be seen that, when a menu item corresponding to a dialing operation is selected from a menu provided using the menu provision method according to the present invention while music is being played, the dialing operation is executed in a screen division manner when the dialing operation is being executed in the multitasking environment.

That is, when a user selects one from the menu included in the menu ribbon, division is performed on a screen corresponding to the operation of the selected menu item (dialing in the example of FIG. 6), so that the menu item may be executed along with the music which has been being played on a single screen.

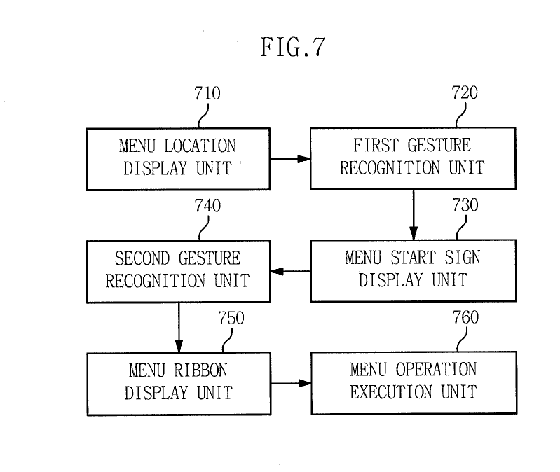

FIG. 7 is a block diagram illustrating a mobile terminal according to an embodiment of the present invention.

Referring to FIG. 7, the mobile terminal according to an embodiment of the present invention includes a menu location display unit 710, a first gesture recognition unit 720, a menu start sign display unit 730, a second gesture recognition unit 740, a menu ribbon display unit 750, and a menu operation execution unit 760.

The menu location display unit 710 displays a specific area such that the specific area is distinguished from the other areas while an arbitrary function is being performed.

Here, the menu location display unit 710 may enable the brightness of the specific area to be different from those of the other areas.

The first gesture recognition unit 720 recognizes a first gesture of a user which is performed on the specific area.

Here, the first gesture may be a touch performed by the user on the part of a screen corresponding to the specific area for a preset time period.

The menu start sign display unit 730 displays a menu start sign, used for displaying a menu ribbon, on the screen in response to the first gesture.

Here, the menu start sign may be a part of the menu ribbon. That is, a part of the menu ribbon is displayed in response to the first gesture, and the menu ribbon may be displayed when the user pulls the corresponding part of the menu ribbon (a second gesture).

The second gesture recognition unit 740 recognizes the second gesture of the user which is performed on the menu start sign.

Here, the second gesture may be the operation of touching the menu start sign and then pulling the menu start sign aside. Here, the menu ribbon may be expanded in response to the movement of a finger of the user who drags the menu start sign.

The menu ribbon display unit 750 displays the menu ribbon in response to the second gesture which is performed on the menu start sign by the user.

Here, the menu ribbon may be expanded in response to the second gesture. That is, when the second gesture corresponds to the operation of touching and then pulling the menu start sign, the menu ribbon may be expanded in response to the movement of the finger of the user who drags the menu start sign.

Here, at least two types of second gestures may be defined and the menus which are displayed on the menu ribbon may be different depending on the types of the second gesture.

The menu operation execution unit 760 executes a function corresponding to a selected menu item in a multitasking environment in response to the selection of the menu item on the menu ribbon by the user.

Here, the menu item selected in the multitasking environment may be executed in a screen division manner or in a pop-up manner.

When the function corresponding to the selected menu item starts, the menu ribbon which was displayed may disappear.

The menu provision method using gestures and the mobile terminal according to the present invention are not limited to the above-described embodiments. Therefore, all or some elements of each embodiment may be selectively combined and configured such that the embodiments may be variously modified.

According to the present invention, a user of a mobile terminal can execute a desired menu item by performing a simple operation without having to return to an initial menu or performing a complicated process on a menu tree.

In particular, the present invention may enable a user to easily execute a desired menu item in a multitasking environment.

Further, the present invention may minimize the inconvenience to a user in such a way that a menu start sign is not displayed when a specific function is performed and the menu start sign is visible only when the user inputs a predetermined gesture.

Further, the present invention may remarkably reduce the number of key manipulations compared to the case where a user closes menu items one by one and then selects another menu item.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of providing a menu using gestures, comprising:
recognizing a first gesture of a user which is performed on a specific area of a screen of a mobile terminal while a function of the mobile terminal is being performed;
displaying a menu start sign, which is used for displaying a menu ribbon, on the screen in response to the first gesture; and
displaying the menu ribbon in response to a second gesture of the user which is performed on the menu start sign.

2. The method as set forth in claim 1, wherein the menu ribbon is expanded in response to the second gesture.

3. The method as set forth in claim 2, wherein the first gesture is a touch performed by the user on a part of the screen corresponding to the specific area for a preset time period.

4. The method as set forth in claim 3, wherein the second gesture is a gesture of dragging the menu start sign on the screen by the user.

5. The method as set forth in claim 4, wherein the menu ribbon is expanded in response to the gesture of dragging the menu start sign on the screen by the user.

6. The method as set forth in claim 5, wherein the menu start sign is a part of the menu ribbon.

7. The method as set forth in claim 3, further comprising displaying the specific area in a different way from the way in which remaining areas of the screen are displayed.

8. The method as set forth in claim 7, wherein the specific area is displayed with brightness different from those of the remaining areas.

9. The method as set forth in claim 3, further comprising executing a function corresponding to a menu item in a multitasking environment in response to a selection of the menu item on the menu ribbon by the user.

10. The method as set forth in claim 9, wherein the executing comprises displaying the menu item selected on the menu ribbon in a screen division manner or in a pop-up manner.

11. The method as set forth in claim 2, wherein:
the second gesture is defined as at least two types; and
the menu displayed on the menu ribbon varies depending on the types of the second gesture.

12. A mobile terminal comprising:
a first gesture recognition unit for recognizing a first gesture of a user which is performed on a specific area of a screen while a function is being performed;
a menu start sign display unit for displaying a menu start sign, used for displaying a menu ribbon, on the screen in response to the first gesture; and
a menu ribbon display unit for displaying the menu ribbon in response to a second gesture of the user which is performed on the menu start sign.

13. The mobile terminal as set forth in claim 12, further comprising a second gesture recognition unit for recognizing the second gesture and
wherein the menu ribbon is expanded in response to the second gesture.

14. The mobile terminal as set forth in claim 13, wherein the first gesture is a touch performed by the user on the screen corresponding to the specific area for a preset time period.

15. The mobile terminal as set forth in claim 14, wherein:
the second gesture is an gesture of dragging the menu start sign on the screen by the user; and
the menu ribbon is expanded in response to a movement of a finger of the user who drags the menu start sign on the screen.

16. The mobile terminal as set forth in claim 15, wherein the menu start sign is a part of the menu ribbon.

17. The mobile terminal as set forth in claim 14, further comprising a menu location display unit for displaying the specific area in a different way from the way in which remaining areas of the screen are displayed.

18. The mobile terminal as set forth in claim 17, wherein the specific area is displayed with brightness different from those of the remaining areas.

19. The mobile terminal as set forth in claim 13, wherein:
the second gesture is defined as at least two types; and
the menu displayed on the menu ribbon varies depending on the types of the second gesture.
